(19) United States
(12) Patent Application Publication
(10) Pub. No.: US 2009/0240351 A1
(43) Pub. Date: Sep. 24, 2009

(54) Programming Electronic Instruments by Logging Commands Into a File Format

(75) Inventors: Kam Foor LEONG, Penang (MY); Mei Kuan CHANG, Penang (MY); Wei Yik HOONG, Penang (MY)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Loveland, CO (US)

(21) Appl. No.: 12/475,594

(22) Filed: May 31, 2009

Related U.S. Application Data
(60) Provisional application No. 61/109,553, filed on Oct. 30, 2008.

(51) Int. Cl. G05B 19/42; G06F 3/048; G06F 9/44; G06F 9/45

(52) U.S. Cl. 700/86; 715/771; 717/108; 717/114; 717/137

(57) ABSTRACT

Electronic instruments are communicatively connected to a processor. An application program is executed by the processor to communicate with the instruments. Electronic instrument commands for communicating with the electronic instruments are output from the processing element. The electronic instrument commands are logged in a file format. The logged electronic instrument commands are converted into code for another application program.

### BACKGROUND OF THE INVENTION

AMM (“AGILENT Measurement Manager”) also known as AMIMM (“AGILENT Modular Instrument Measurement Manager”) by AGILENT TECHNOLOGIES of Santa Clara, Calif., USA, is software that allows a user to control electronic instruments, for example, modular test and measurement instruments. AMM is usually run on a computer, such as a personal computer. A graphical user interface is generated on a display of the computer to represent a simulated instrument panel of the electronic instruments. The graphical user interface is referred to as a simulated instrument panel since it is displayed on a computer monitor remote from the electronic instruments, rather than on the instruments themselves. In response to user input to the simulated instrument panel, the AMM software outputs instrument commands from the computer to the electronic instruments and also receives data signals from the electronic instruments. The instrument commands can be SCPI (“Standard Commands for Programmable Instruments”) Input/Output commands or IVI Input/Output commands, for example. The SCPI and IVI Standards specify command structures and syntaxes for programmable instrument control. AMM is often used to configure or verify modular electronic measurement instruments, for example, by configuring the channels, setting ranges, setting sampling rates, etc.

AMM can be used to control, including configuring or obtaining data from, electronic instruments such as AGILENT's U2300A, U2500A, and U2600A Series Multifunction USB Modular DAQ. AMM can also be used to control U2700A Series USB Modular Instruments such as the U2781A instrument chassis and U2802A thermocouple signal conditioning.

AMM is an example of an electronic instrument control program. Other examples are “NI Scope”, “NI Test Panel for NI-DAQmx Device” and “DAQ Assistant”. These electronic instrument control programs typically do not perform test sequencing or automation functions. Thus, controlling the electronic instruments becomes a rather tedious and repetitive task.

In this disclosure, “program” is defined to include software or firmware programs or steps executed by a computing machine. “Program” is further defined to include a portion of a program such as computer sub-routines or sub-programs. A program can be stored on any storage media and executed using any type of computer, or internal or external processor, such as a CPU, as would be understood by those skilled in the art.

A separate Integrated Development Environment (“IDE”) program is usually used for programming the test sequencing or automation functions. IDE programs assist a user in developing software applications.

Examples of IDEs are AGILENT VEE, NATIONAL INSTRUMENTS' LabVIEW, MATLAB, MICROSOFT Visual Studio, Visual Basic 6.0, Visual Basic.NET, C/C++/C#, and Java.

AGILENT VEE and NATIONAL INSTRUMENTS' LabVIEW, in particular, are IDEs used to program the test sequencing or automation functions and generate electronic instrument commands for communicating with the electronic instruments. As with the electronic instrument control program, the electronic instrument commands can be SCPI (“Standard Commands for Programmable Instruments”) Input/Output commands or IVI Input/Output commands, for example.

It would be desirable to be able to combine the convenient input of commands or obtaining data using the electronic instrument control program such as AMM with the time saving test sequencing and automation functions of an IDE program such as VEE.

### BRIEF DESCRIPTION OF THE DRAWINGS

Further preferred features of the invention will now be described for the sake of example only with reference to the following figures, in which:

FIG. 1 is a block diagram illustrating a test-system hardware architecture of the present invention for measuring an item.

FIG. 2 is a block diagram illustrating details of a computing subsystem of the test-system architecture of FIG. 1.

FIG. 3 is a high-level architecture diagram of software layers of the present invention.

FIG. 4 shows a user interface of an application program for logging electronic instrument control commands in a file format.

FIG. 5 which shows a “Command Logger” user interface of the present invention.

FIG. 6 shows a pull-down menu of a user interface for converting a file of logged commands having a file format into code for an IDE program.

FIG. 7 shows a “Convert Window” user interface for converting a file of logged commands having a file format into code for an IDE program.

FIG. 8 shows exemplary VEE objects/functions generated by a conversion application tool by converting the file of logged commands.

FIG. 9 shows steps for a method for programming electronic instruments according to the present invention.

FIG. 10 shows steps for initializing the hardware and software for performing the method of FIG. 9.

FIG. 11 shows steps for outputting electronic instrument commands for communicating with the electronic instruments of FIGS. 1 and 2.

FIG. 12 shows steps for a “Command Logger” function for logging the electronic instrument control commands in the file format in order to perform the method of FIG. 9.

FIG. 13 shows steps for converting commands from the logged commands file into source or object code for the IDE program of FIG. 2.

FIGS. 14a and 14b show an example of the logged commands file having an XML file format.

FIG. 15 shows a command list for use in converting the commands of FIGS. 14a and 14b.

### DETAILED DESCRIPTION

The present invention allows for saving electronic instrument commands, generated by an electronic instrument control program, in a file format for use by other programs.

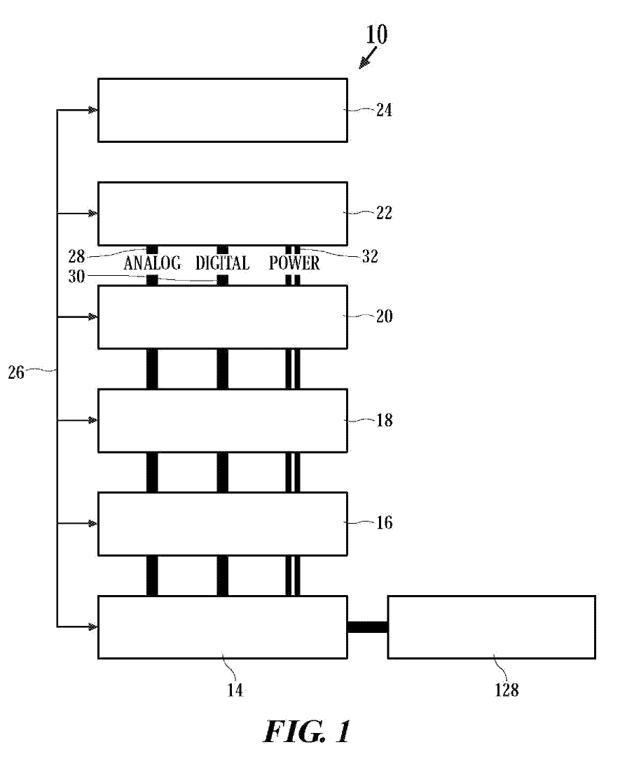

FIG. 1 is a block diagram illustrating a test-system hardware architecture 10 of the present invention for measuring an item to be measured 12 which can be, for example, a Device Under Test (DUT) or any signal, material, device or system to be measured. The system 10 includes six general subsystems. A mass interconnect sub system 14 provides a DUT-to-system wiring interface. A switching subsystem 16 includes relays that interconnect system instrumentation and loads to the item to be measured 12. There is also a subsystem 18 for DUT-specific connections to loads, serial interfaces, etc. An instrumentation subsystem 20 includes electronic measurement instruments along with stimulus instruments and sensors for measuring the item to be measured 12. This instrumentation subsystem 20 can include, for example, an oscilloscope, a spectrum analyzer, a network analyzer, a multimeter or any modular measurement instruments. In general, the instrumentation subsystem 20 of the present invention can include one or more electronic instruments such as test and measurement instruments. A power source subsystem 22 provides power to the item to be measured 12. Finally, a computing subsystem 24 can include a system controller, computer, software and I/O (Input/Output).

The various subsystems can be connected through one or more physical interface 26, for example an I/O Bus, which might be selected from VXI, GPIB (General-Purpose Instrumentation Bus), RS-232, FireWire, MXI, USB (Universal Serial Bus), LAN (Local Area Network), or other physical interfaces. Additional Analog 28, Digital 30 and Power 32 lines can also connect the various subsystems. Not all of these subsystems are necessary for every configuration of the present invention.

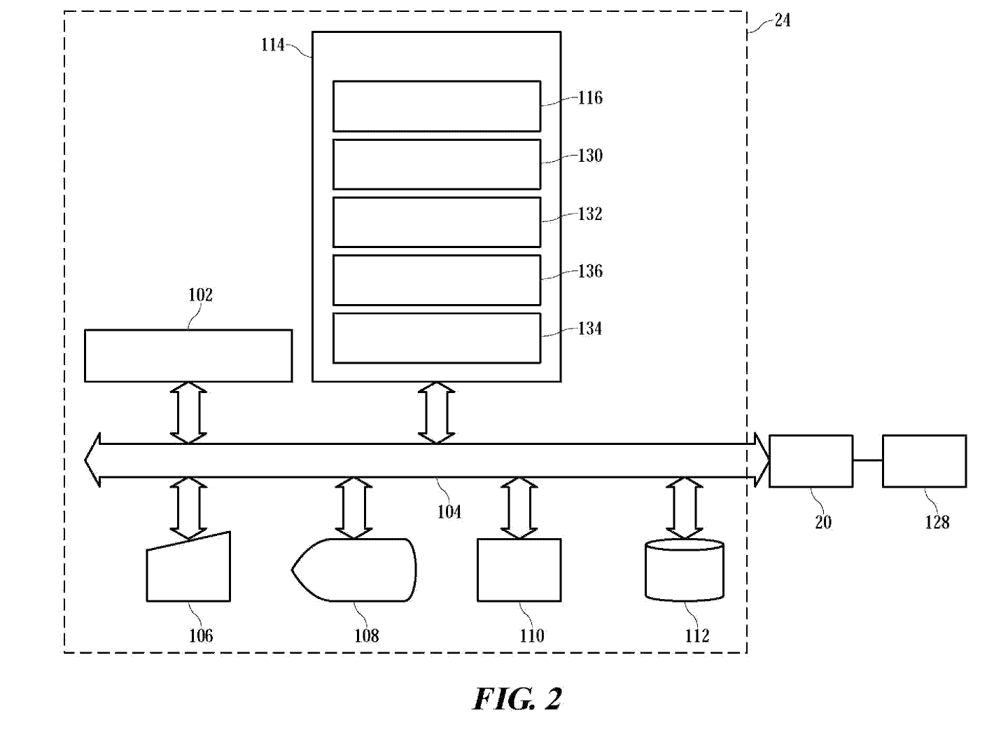

FIG. 2 is a block diagram emphasizing details of the computing subsystem 24 of the test-system architecture 10 of FIG. 1. The computing subsystem 24 contains a processing element 102, which can be an internal or external processor, and memory 114 which connect to the other components of the system through a physical interface 104. The physical interface 104 can be the same as or separate from the physical interface 26 of FIG. 1.

A disk 112, the memory 114 or other type of storage are used by the system to store several types of files according to the present invention which can include: an electronic instrument control program 116; a logged command file 130 for logging instrument commands generated by the electronic instrument control program 116; a converted command file 132; an IDE program 136; and a conversion application tool 134.

In general, the electronic instrument control program 116 and the IDE program 136 can be any type of application programs for use with electronic instruments. Moreover, in other embodiments, both of the programs can be electronic instrument control programs or both of the programs can be IDE programs.

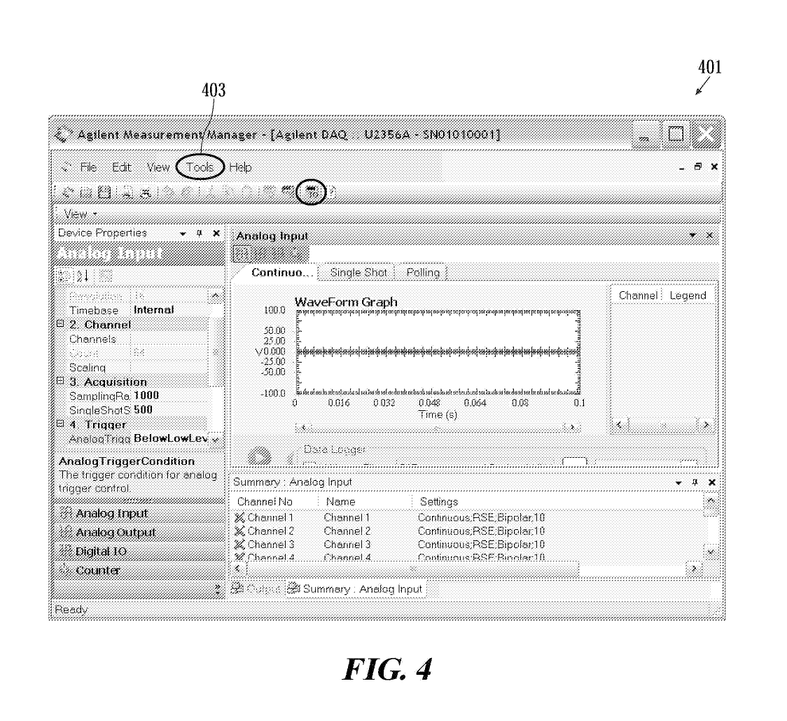

The physical interface 104 connects the computing subsystem 24 to instrumentation subsystem 20 which can be any test and measurement equipment, for example. A display device 108 allows the system to output information to the user. The display device 108 can be a single computer monitor, multiple computer monitors, a projector, a screen or in general any device capable of displaying the required software visual displays. The display device 108 can display a graphical user interface 401 described in more detail below with reference to FIG. 4. A keyboard 106 allows a user to input textual data to the system. A mouse 110, or more generally any pointing device, allows a user to input data, select items displayed on the display device 108.

Also shown is the item to be measured 12. Connected to the instrumentation subsystem 20 and item to be measured 12, directly to or through the physical interface 104, can be the mass interconnect sub system 14, switching subsystem 16 and subsystem for DUT-specific connections 18 as illustrated in FIG. 1.

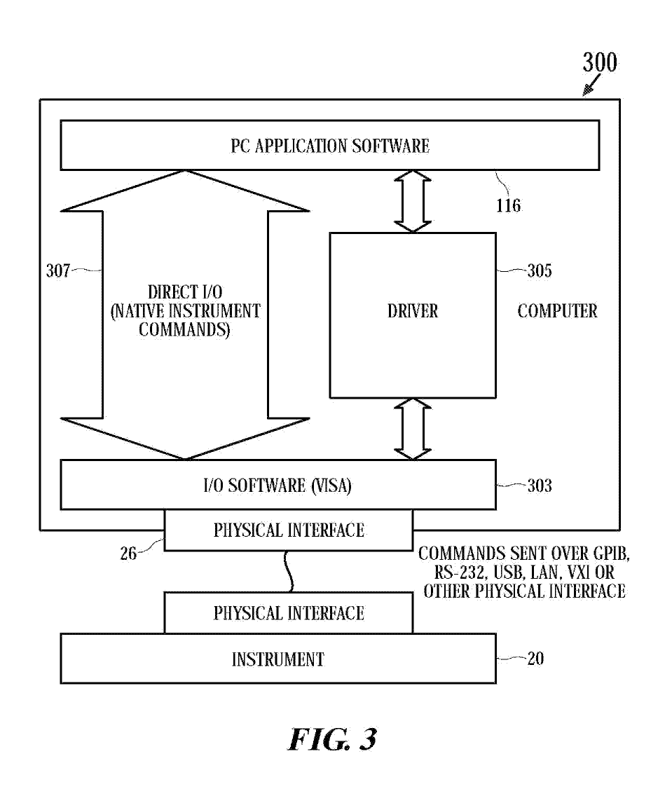

FIG. 3 is a high-level architecture diagram of software layers 300 of the present invention. At the top layer are application programs which can include the electronic instrument control program 116 which could be such as AMM. The application programs can also include the IDE program 136, which might be one or more of VEE, LabVIEW, MATLAB, Visual Studio, Visual Basic 6.0, Visual Basic.NET, C/C++/C#, or Java. These application programs are stored in the disk 112 and memory 114 of FIG. 2.

The application programs 116, 136 communicate with the instrumentation subsystem 20 over the physical interface 26, for example an I/O Bus, which might be selected from VXI, GPIB (General-Purpose Instrumentation Bus), RS-232, FireWire, MXI, USB (Universal Serial Bus), LAN (Local Area Network), or other physical interfaces.

I/O software 303 is used so that the application programs 116, 136 can communicate with the instrumentation subsystem 20. AGILENT I/O Libraries Suite, Plug and Play drivers, IVI-COM drivers, and VISA/SICL (Virtual Instrument Software Architecture and Standard Instrument Control Library) are examples of such I/O software.

The communication between the application programs 116, 136 and the I/O software 303 can be done using drivers 305 or through direct I/O 307. Examples of drivers are IVI, Plug and Play drivers, IVI-COM drivers, and VISA/SICL. Direct I/O can be done with SCPI commands or, in the case of a Ethernet-based LAN physical interface 26, the I/O operations can be performed using TCP/IP's sockets to perform instrument I/O directly without a host-side driver.

The steps for programming, or more generally communicating with, electronic instruments according to an embodiment of the present invention are now explained with reference to the flow charts of FIGS. 9-13 and additionally with reference to FIGS. 1-8, 14 and 15.

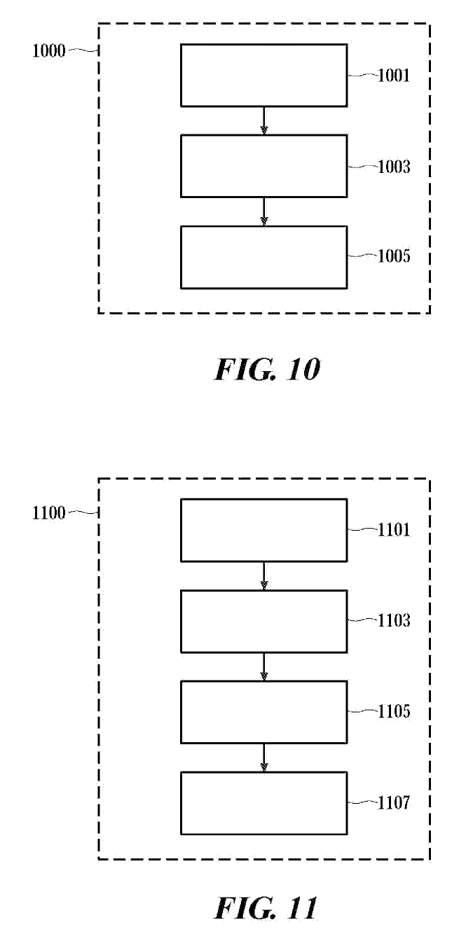

FIG. 9 illustrates a method for controlling electronic instruments according to the present invention. BLOCK 1000 of FIG. 9 comprises steps for initializing the hardware and software for performing the method of the present invention. The steps of BLOCK 1000 are shown in more detail in FIG. 10. STEP 1001 comprises communicatively connecting a processing element 102 (FIG. 2) to the electronic instruments of the instrumentation subsystem 20 (FIGS. 1 and 2). The connection between the processing element 102 and the electronic instruments can be through the physical interface 26 (FIG. 1) and or physical interface 104 (FIG. 2).

At STEP 1003, when electronic instrument control program 116 is to be executed, the electronic instrument control program 116 is first transferred from the storage 112 and stored in memory 114 for processing by the processing element 102 (FIG. 2). At this step, the IDE program 136 can also be transferred from the storage 112 and stored in memory 114 for processing by the processing element 102.

At STEP 1005, the electronic instrument control program 116 is executed by the processing element 102 to generate commands for communicating with the one or more electronic instruments of the instrumentation subsystem 20.

BLOCK 1100 of FIG. 9 comprises steps for generating electronic instrument control commands for communicating with the electronic instruments of the instrumentation subsystem 20. FIG. 11 shows details of the steps of BLOCK 1100.

At STEP 1101 the electronic instrument control program 116 generates the graphical user interface 401 of FIG. 4 which is displayed on the display device 108 as shown in FIG. 2. The graphical user interface 401 is generated on the display device 108 to represent a simulated instrument panel of one or more electronic instruments of the instrumentation subsystem 20. The graphical user interface 401 is referred to as a simulated instrument panel since it is displayed on a display device 108, such as a computer monitor, remote from the electronic instruments of the instrumentation subsystem 20, rather than on the electronic instruments themselves.

At STEP 1103, a user provides input to the graphical user interface 401 to control the electronic instruments of the instrumentation subsystem 20 similar to how the user would directly manipulate an actual instrument panel of the electronic instruments. The user provides the input using the keyboard 106 and mouse 110 of FIG. 2.

In response to the user input to the to the graphical user interface 401 the electronic instrument control program 116 generates commands to control, including configuring or obtaining data from, the electronic instruments of the instrumentation subsystem 20. Commands for configuring the electronic instruments can be for configuring channels, setting ranges, or setting sampling rates, for example. The data obtained from the electronic instruments is also displayed on the graphical user interface 401. These graphical user interface 401 features can be found in the AMM electronic instrument control program, as referred to above.

At STEP 1105 the electronic instrument control program 116 outputs from the processing element 102 electronic instrument control commands 1109 for controlling the electronic instruments of the instrumentation subsystem 20 (FIG. 2). The commands can be SCPI or IVI commands, for example. These commands are sent to the I/O software 303 (FIG. 3). The commands 1109 can also be sent to a “Command Logger” function of the electronic instrument control program 116 which is described below with reference to BLOCK 1200.

At STEP 1107 the electronic instrument control commands 1109 are transmitted through the physical interface 104 to the instrumentation subsystem 20.

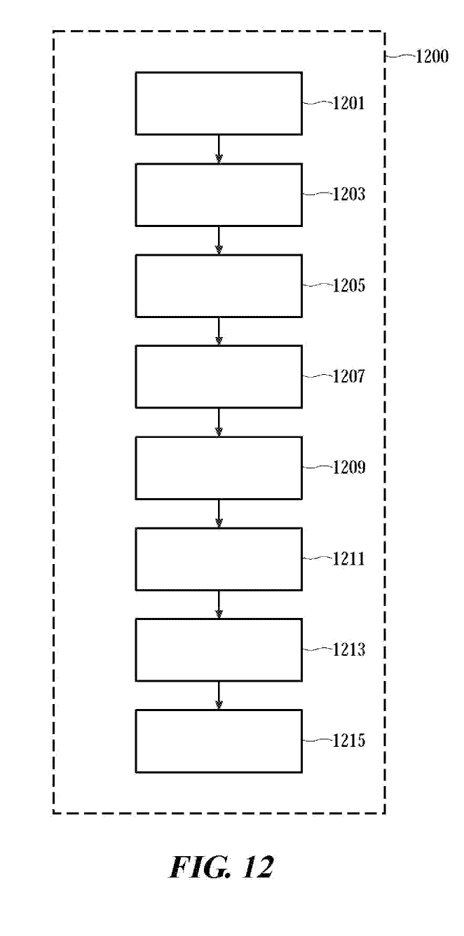

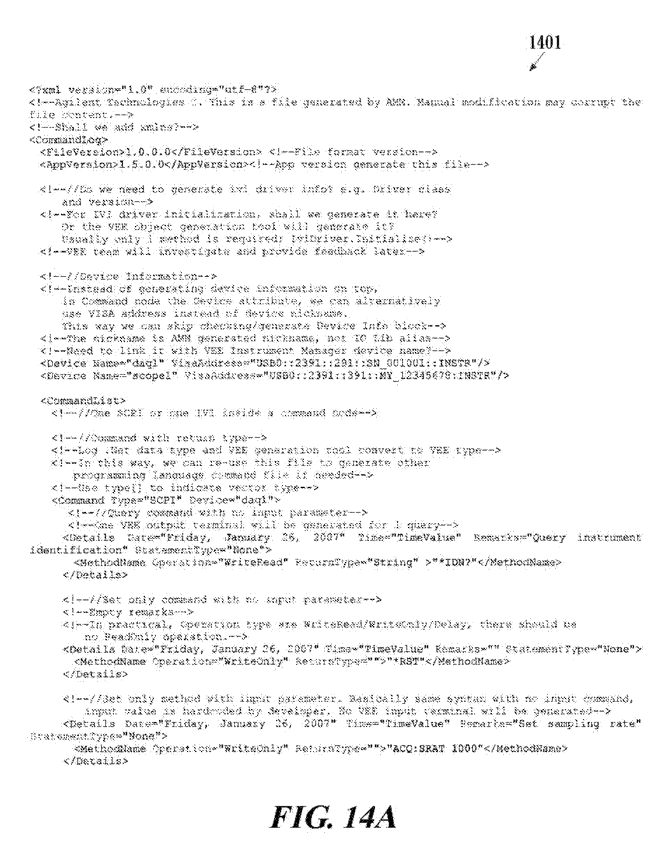

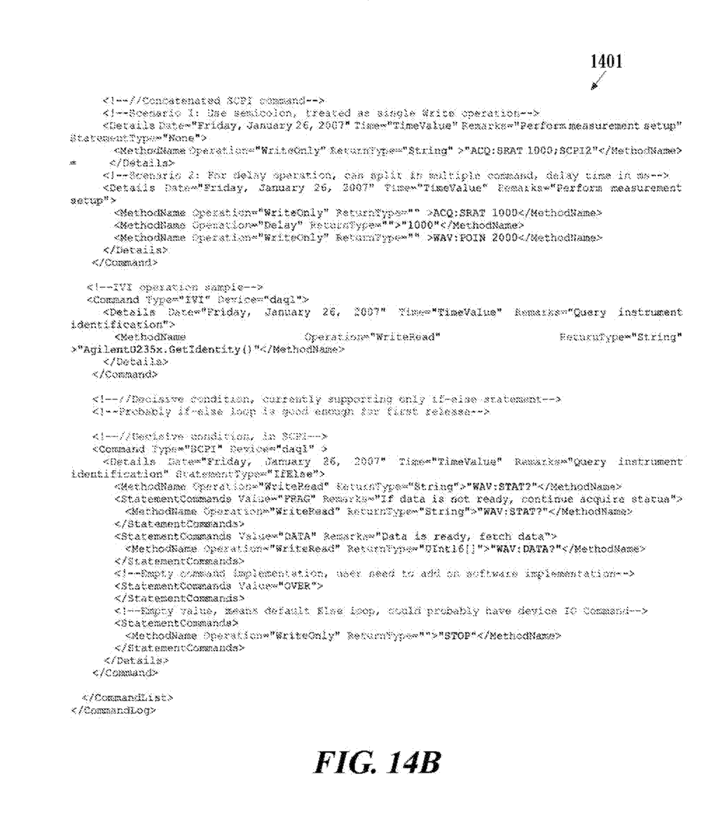

BLOCK 1200 comprises steps for a “Command Logger” function of the electronic instrument control program 116 for logging the electronic instrument control commands 1109 in a file format 1401 as shown in FIGS. 14A and 14B. BLOCK 1200 can be executed in parallel with the steps of BLOCK 1100. The 102 electronic instrument control commands 1109 generated at BLOCK 1100 can therefore be transmitted directly through the physical interface 104 to the instrumentation subsystem 20, or else can be transmitted to the BLOCK 1200 for being logged in a file format 1401, or else can be transmitted to both either at the same time or different times. FIG. 12 shows details of the steps of BLOCK 1200.

To begin logging the commands, at STEP 1201a user uses the mouse 110 of FIG. 2 to select “Tools” 403 from the menu of the graphical user interface 401 on the display 108 of FIG. 2. Then the user selects “Command Logger” to start the “Command Logger” function. The command logger function is started before the user input of STEP 1103 (FIG. 11) is received and before acquiring the data that is to be logged.

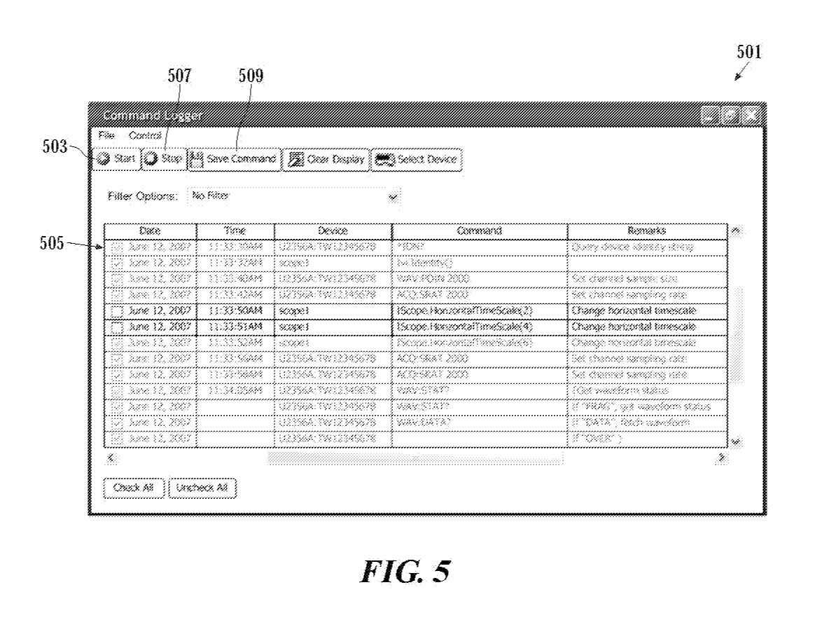

At STEP 1203a “Command Logger” user interface 501 of FIG. 5 is displayed on the display 108 of FIG. 2.

At STEP 1205 the user uses the mouse 110 of FIG. 2 to click on the start button 503 of FIG. 5 to begin the logging process.

As described above, at STEP 1107 of BLOCK 1100, the electronic instrument control program 116 outputs from the processing element 102 electronic instrument control commands 1109 for controlling the electronic instruments of the instrumentation subsystem 20. At STEP 1207 these electronic instrument control commands 1109 are logged in the file format 1401.

At STEP 1209 the electronic instrument control commands 1109 along with other information is displayed in a display area 505 of the “Command Logger” user interface 501.

At STEP 1211 the user uses the mouse 110 of FIG. 2 to click on the stop button 507 of FIG. 5 to end the logging process.

At STEP 1213 the user uses the mouse 110 of FIG. 2 to click on the “save command” button 509 of FIG. 5 to save the logged commands file 130.

The logged command file 130 of FIG. 2 can use XML, HTML, Text, or other formats to store the electronic instrument control commands 1109 generated by the electronic instrument control program 116. FIGS. 14A and 14B show an example of the file 130 in an XML file format 1401.

At STEP 1215 the logged commands file 130 is saved in the memory 114 or disk 112 of FIG. 2.

At BLOCK 1300 of FIG. 9 the commands of the logged commands file 130 (FIG. 2) having the file format 1401 (FIGS. 14A and 14B) are converted into source or object code for the IDE program 136 (FIG. 2) and stored in the converted command file 132 of FIG. 2. In other embodiments, rather than converting the commands into IDE program code, the commands can be converted into code for any other type of program used with electronic instruments. In a specific example, the electronic instrument control program 116 can be AMM, and the IDE program 136 can be VEE.

The conversion is performed by the conversion application tool 134 (FIG. 2) which converts the commands in the logged command file 130 into the commands of the converted command file 132. The conversion application tool 134 can be part of the electronic instrument control program 116, the IDE program 136 or can be a separate program, such as the program that is to run the code of the converted command file 132.

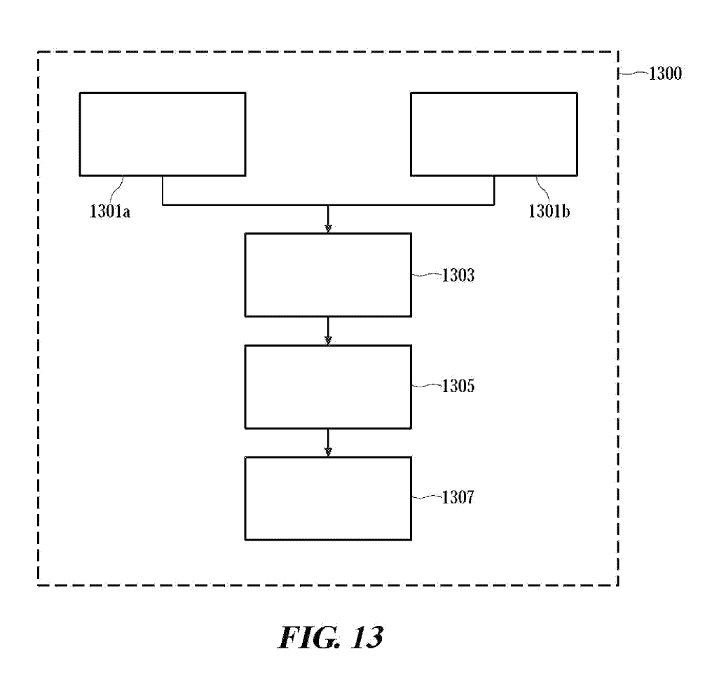

FIG. 13 shows details of the steps of BLOCK 1300. At STEP 1301a, in the embodiment in which the conversion application tool 134 is part of the electronic instrument control program 116, the user uses the mouse 110 of FIG. 2 to click on File, and then selects “Convert Command File” from the pull-down menu of the “Command Logger” user interface 501 of FIG. 5.

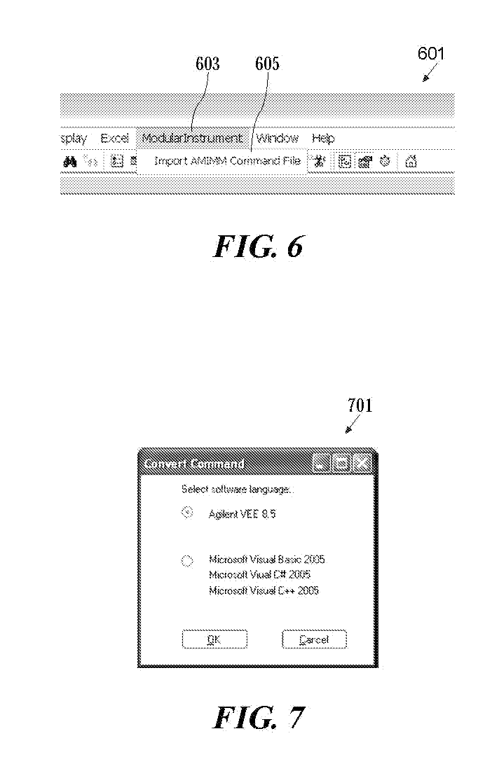

Alternatively, if the conversion application tool 134 is part of the IDE program 136, STEP 1301b is performed whereby the user uses the mouse 110 of FIG. 2 to click on “Modular Instrument” 603, and then selects “Import AMIMM Command File” 605 from the pull-down menu of a user interface 601 of the IDE program 136 as shown in FIG. 6.

In response to STEP 1301a or 1301b, at STEP 1303 a “Convert Window” user interface 701 of FIG. 7 is displayed on the display 108 of FIG. 2.

At STEP 1305 the user uses the mouse 110 of FIG. 2 to select a particular IDE program type 136 into which the logged commands stored in the file 130 and having the file format 1401 are to be converted.

At STEP 1307 the conversion application tool 134 can perform steps to query the user for additional information in order to convert the logged commands stored in the file 130 and having the file format 1401 into the desired format.

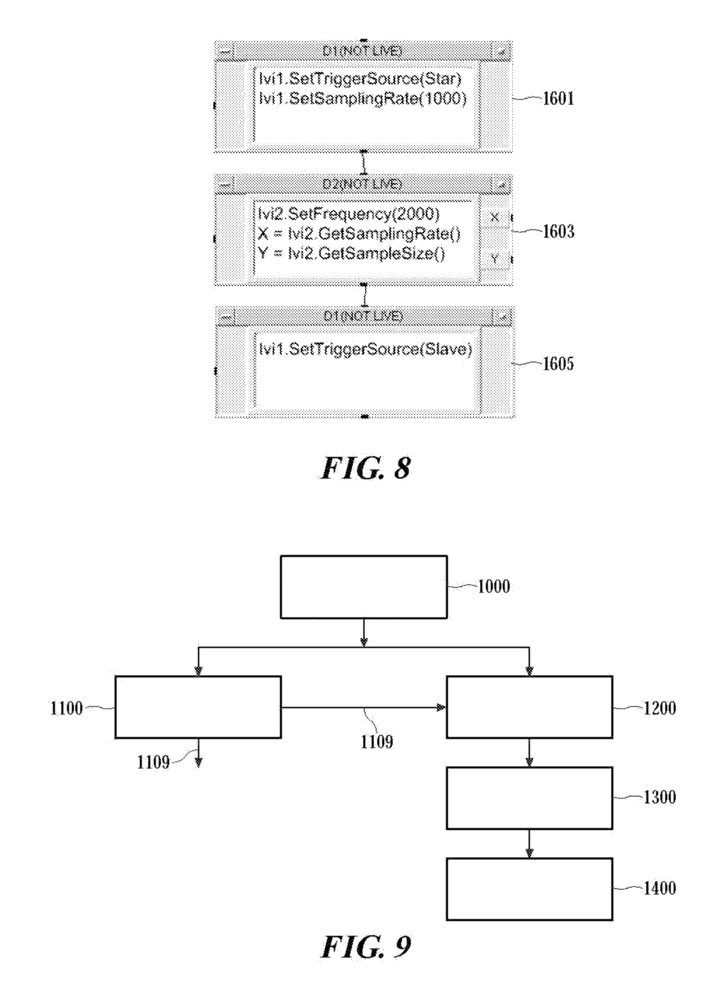

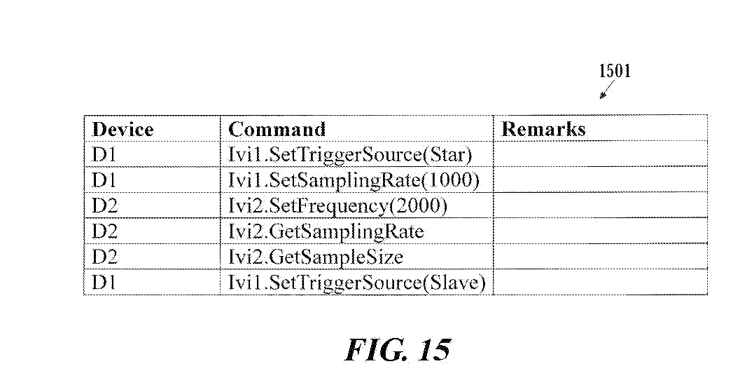

The converted code for the IDE program (in this case VEE), can be generated using the command list 1501 of FIG. 15. FIG. 8 shows exemplary VEE objects/functions 1601, 1603, 1605 generated by the conversion application tool 134. The generated commands shown in the command list 1501 show up in sequence in the generated VEE objects 1601, 1603, 1605. Consecutive commands for a particular device will be generated into a single VEE Direct Input/Output object when the commands are SCPI commands. Consecutive commands for a particular device will be generated into a single VEE IVI command block when the commands are IVI commands.

Following this specific example, the conversion application tool 134 can convert the logged commands stored in the file 130 into source code or directly into object code for any other application programs such as VEE, LabVIEW, MATLAB, Visual Studio, Visual Basic 6.0, Visual Basic.NET, C/C++/C#, Java, AMM, MAX or “DAQ Configuration Assistant”. These other application programs can then run this source or object code directly, thereby saving the time the user would usually need to write such source or object code.

At BLOCK 1400, the source or object code generated by the conversion application tool 134 is run by any of the above mentioned application programs, for example VEE, to control the instrumentation subsystem 20 to measure the item to be measured 12 (see FIG. 2).

In the foregoing specification, the invention has been described with reference to specific exemplary embodiments thereof. The specification and drawings are, accordingly, to be regarded in an illustrative sense rather than a restrictive sense.

1. A method for controlling an electronic instrument using electronic instrument commands comprising the steps of:
executing a first program to generate a simulated instrument panel remote from the electronic instrument and to generate the electronic instrument commands;
acquiring, by the first program, user input from the simulated instrument panel;
generating, by the first program, the electronic instrument commands in response to the user input;
logging in a file format the electronic instrument commands; and
generating, from the logged electronic instrument commands, source or object code for an Integrated Development Environment program.

2. The method of claim 1, wherein the file format is XML format.

3. The method of claim 1, wherein the electronic instrument commands are SCPI commands or IVI commands.

4. The method of claim 2, wherein the Integrated Development Environment program converts the XML formatted electronic instrument commands from the XML format into the Integrated Development Environment source or object code.

5. The method of claim 2, wherein an object generation tool of the Integrated Development Environment program converts the electronic instrument commands from the XML format into an object of the Integrated Development Environment program.

6. The method of claim 2, wherein the first program converts the electronic instrument commands from the XML format into an object of the Integrated Development Environment program.

7. The method of claim 1, further comprising the steps of:
executing the Integrated Development Environment source or object code by the Integrated Development Environment program; and
outputting the electronic instrument commands from the Integrated Development Environment program to the electronic instrument to control the electronic instrument.

8. The method of claim 1, wherein the electronic instrument is a modular instrument.

9. The method of claim 1, further comprising the step of controlling additional electronic instruments using the first program.

10. A system for controlling an electronic instrument comprising:
a simulated instrument panel remote from the electronic instrument for receiving user input;
a first program for generating the simulated instrument panel and for acquiring the user input from the simulated instrument panel and in response generating electronic instrument commands for controlling the electronic instrument;
a file for logging the electronic instrument commands; and
an Integrated Development Environment program including source or object code generated from the electronic instrument commands logged in the file.

11. The system of claim 10, wherein the format of the file is XML format.

12. The system of claim 10, wherein the electronic instrument commands are SCPI commands or IVI commands.

13. The system of claim 11, wherein the Integrated Development Environment program converts the XML formatted electronic instrument commands from the XML format into the Integrated Development Environment source or object code.

14. The system of claim 11, further comprising an object generation tool of the Integrated Development Environment program for converting the electronic instrument commands from the XML format into an object of the Integrated Development Environment program.

15. The system of claim 11, wherein the first program converts the XML formatted electronic instrument commands from the XML format into the Integrated Development Environment source or object code.

16. The system of claim 10, wherein:
the Integrated Development Environment source or object code is executed by the Integrated Development Environment program to output the electronic instrument commands from the Integrated Development Environment program to the electronic instrument to control the electronic instrument.

17. The system of claim 10, wherein the electronic instrument is a modular instrument.

18. The system of claim 10, further comprising additional electronic instruments controlled by the system by executing the first program.
